(19) United States
(12) Patent Application Publication
(10) Pub. No.: US 2026/0359345 A1
(43) Pub. Date: Nov. 12, 2026

(54) Generating Conversational Outputs to User Queries

(71) Applicant: Spotify AB, Stockholm (SE)

(72) Inventors: Henrik Lindström, Stockholm (SE); Francesco Fabbri, Barcelona (ES); Ghazal Fazelnia, New York, NY (US); Jacqueline Wood, New York, NY (US); José Luis Redondo Garcia, Cáceres (ES)

(21) Appl. No.: 19/671,094

(22) Filed: May 7, 2026

Related U.S. Application Data
(60) Provisional application No. 63/803,288, filed on May 9, 2025.

(51) Int. Cl. G06F 16/435; G06F 16/438

(52) U.S. Cl. CPC G06F 16/435; G06F 16/438

(57) ABSTRACT

Example implementations include methods and systems that relate to generating conversational outputs to user queries. An example method includes receiving a conversational user requesting user-specific information associated with a streaming media platform. The method includes generating, by an orchestrator of the conversational system, a programmatic recipe for processing the conversational query. The programmatic recipe specifies one or more of (i) how a retriever tool of the conversational system is to be used in processing the conversational user query or (ii) how a recommender tool of the conversational system is to be used in processing the conversational user query. The method includes processing the conversational user query according to the programmatic recipe to generate a conversational output. A parser tool is configured to generate the conversational output based on at least one of (i) an output generated by the retriever tool or (ii) an output generated by the recommender tool.

### CROSS-REFERENCE TO RELATED APPLICATION

The present application claims the benefit of U.S. Provisional Patent Application No. 63/803,288, filed May 9, 2025. The contents of which are hereby incorporated by reference in their entirety.

### FIELD OF THE INVENTION

The present disclosure relates to the field of streaming media platforms. Specifically, the present disclosure pertains to methods, systems, and devices for generating conversational outputs to user queries requesting user-specific information.

### BACKGROUND

A streaming media platform may require that a user select specific media content (e.g., music, podcasts, etc.) for media consumption. To illustrate, the streaming media platform may include a browse function that enables the user to manually browse through recommended media content and select media content for playback. Additionally, or in the alternative, the streaming media platform may include a search function that enables the user to input (e.g., vocally input or textually input) information for desired media content and select, from the results of the search function, media content for playback during a media consumption session. However, with regards to a user’s personalized experience, existing streaming media platforms are limited in their ability to meaningfully engage in conversational audio with a user.

Existing streaming media platforms do not provide techniques for a personalized conversational interaction with a user based on user preferences. To provide an example, existing streaming media platforms may recommend media content for user consumption on a dedicated page (e.g., a recommendation page). However, the user may not be able to conversationally ask the streaming media platform to recommend media content based on the user’s historical preferences and receive a conversational response. As another example, existing streaming media platforms may store metadata associated with media items previously accessed by the user. However, the user may not be able to conversationally ask the streaming media platform to discuss their recent musical preferences and receive a conversational response.

### SUMMARY

Various implementations disclosed herein provide conversational outputs to user queries requesting user-specific information. In particular, the present disclosure describes a conversational system that can dynamically utilize different tools (e.g., agents) to generate responses to conversational user queries directed to a personalized experience on a streaming media platform. In particular, the conversational system can evaluate the user’s media preferences and generate a conversational output to a conversational user query based on the user’s media preferences.

To illustrate, over the course of time, a user of the streaming media platform may develop particular patterns and tendencies while listening to audio (e.g., music, podcasts, etc.). For example, the user may typically access the streaming media platform to listen to audio during certain hours of the day (e.g., peak listening hours), the user may typically engage with audio from particular artists, the user may repeat certain audio tracks, the user may typically listen to certain types of audio (e.g., music vs. podcasts), etc. Based on the patterns and tendencies of the user, the conversational system may use different tools to generate conversational responses to conversational user queries.

To illustrate, the conversational system may include an orchestrator, a retriever tool, a recommender tool, and a parser tool. In some implementations, one or more components (e.g., tools) of the conversational system can be implemented using a language model, such as a large language model (LLM). For example, the orchestrator may utilize a language model to interpret (e.g., understand) a conversational user query, and the parser tool may utilize a language model to generate a conversational output to the conversational user query.

The orchestrator may be configured to receive a conversational input query from the user. For illustrative purposes, let’s assume the conversational input query from the user is the user saying “If my listening history were turned into a festival, which artists would be on the lineup”. A voice-to-text application may convert the phrase into text and provide the text to the orchestrator of the conversational system. The orchestrator may be configured to determine which specialized tools (e.g., the retriever tool, the recommender tool, or both) should be used to process at least a portion of the input query. In particular, the orchestrator may (i) interpret the user query using a language model, (ii) generate a programmatic recipe that defines which specialized tools are to be involved in generating the conversational response to the input query, and (iii) assign tasks to each tool.

To respond to at least part of the input query, the orchestrator may direct the retriever tool to analyze a listening history of the user. For example, the retriever tool may be configured to evaluate (e.g., fetch and analyze) the listening history of the user. In particular, the retriever tool may be configured to identify the listening patterns and tendencies of the user. To illustrate, the retriever tool may analyze information (e.g., metadata of audio previously listened to by the user) to (i) identify artists typically/historically listened to by the user, (ii) genres typically/historically listened to by the user, (iii) eras of music typically/historically listened to the by user, etc. In some scenarios, to accomplish this, the retriever tool may access a memory module that transforms the user’s listening memory into a format for temporal analysis. For example, the retriever tool may have access to a long-term memory that stores metadata indicative of user’s historical and/or recent media interactions. In particular, the long-term memory may be used to collect and store user inputs, system outputs, and corresponding metadata over time. The stored metadata may be leveraged for conversational responses, as described herein, to reduce use of computational resources. As such, using the long-term memory, the retriever tool may identify more recent listening patterns and tendencies of the user. Based on the listening patterns and tendencies of the user, the retriever tool may be configured to generate retriever metadata that indicates the user’s taste in music. In some embodiments, the long-term memory may also be used to identify listening patterns and tendencies developed over the course of years. In these embodiments, retriever tool may weigh more recent patterns/tendencies with older patterns/tendencies.

Additionally, to respond to at least part of the input query, the orchestrator may direct the recommender tool to recommend different music for the user to improve its taste. To accomplish this, the recommender tool may identify different artists, genres, or eras of music than those identified by the retriever tool. In some scenarios, the recommender tool may utilize an application programming interface (API) call to a media library of the streaming media platform to identify different music for the user. Based on the recommended music, the recommender tool may be configured to generate recommender metadata that indicates recommended music for the user.

Using a language model, the parser tool may be configured to convert the retriever metadata and the recommender metadata into a conversational response to the input query. For example, using the retriever metadata and the recommender metadata, the parser tool may generate the conversational response to offer suggestions of artists that would be on the lineup.

Accordingly, a first example embodiment may involve a method of generating conversational outputs to user queries. The method includes receiving, by a conversational system, a conversational user query requesting user-specific information associated with a streaming media platform. The method includes generating, by the conversational system using an orchestrator of the conversational system, a programmatic recipe for processing the conversational user query. The programmatic recipe specifies one or more of (i) how a retriever tool of the conversational system is to be used in processing the conversational user query or (ii) how a recommender tool of the conversational system is to be used in processing the conversational user query. To process at least part of the conversational user query, the retriever tool is configured to access a memory that stores information indicative of user-specific interactions with the streaming media platform and output first structured data representing select user-specific interactions with the streaming media platform. To process at least part of the conversational user query, the recommender tool is configured to communicate with one or more recommendation systems of the streaming media platform and output second structured data representing select user-specific media recommendations associated with the streaming media platform. The method includes processing, by the conversational system, the conversational user query according to the programmatic recipe to generate a conversational output. A parser tool of the conversational system is configured to generate the conversational output based on at least one of the first structured data or the second structured data.

A second example embodiment may involve a device. The device includes a system memory and a processor coupled to the system memory. The processor hosts a conversational system. The conversational system is configured to receive a conversational user query requesting user-specific information associated with a streaming media platform. The conversational system is configured to generate, using an orchestrator of the conversational system, a programmatic recipe for processing the conversational user query. The programmatic recipe specifies one or more of (i) how a retriever tool of the conversational system is to be used in processing the conversational user query or (ii) how a recommender tool of the conversational system is to be used in processing the conversational user query. To process at least part of the conversational user query, the retriever tool is configured to access a memory that stores information indicative of user-specific interactions with the streaming media platform and output first structured data representing select user-specific interactions with the streaming media platform. To process at least part of the conversational user query, the recommender tool is configured to communicate with one or more recommendation systems of the streaming media platform and output second structured data representing select user-specific media recommendations associated with the streaming media platform. The conversational system is configured to process the conversational user query according to the programmatic recipe to generate a conversational output. A parser tool of the conversational system is configured to generate the conversational output based on at least one of the first structured data or the second structured data.

A third example embodiment may involve a non-transitory computer-readable medium. The non-transitory computer-readable medium includes instructions that, when executed by a processor that hosts a conversational system, cause the conversational system to perform operations. The operations include receiving a conversational user query requesting user-specific information associated with a streaming media platform. The operations include generating, using an orchestrator of the conversational system, a programmatic recipe for processing the conversational user query. The programmatic recipe specifies one or more of (i) how a retriever tool of the conversational system is to be used in processing the conversational user query or (ii) how a recommender tool of the conversational system is to be used in processing the conversational user query. To process at least part of the conversational user query, the retriever tool is configured to access a memory that stores information indicative of user-specific interactions with the streaming media platform and output first structured data representing select user-specific interactions with the streaming media platform. To process at least part of the conversational user query, the recommender tool is configured to communicate with one or more recommendation systems of the streaming media platform and output second structured data representing select user-specific media recommendations associated with the streaming media platform. The operations include processing the conversational user query according to the programmatic recipe to generate a conversational output. A parser tool of the conversational system is configured to generate the conversational output based on at least one of the first structured data or the second structured data.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a block diagram illustrating a media content delivery system, in accordance with example embodiments.

FIG. 2 is a block diagram illustrating an electronic device, in accordance with example embodiments.

FIG. 3 is a block diagram illustrating a media content server, in accordance with example embodiments.

FIG. 4 is a block diagram illustrating a device for generating conversational outputs to user queries requesting user-specific information, in accordance with example embodiments.

FIG. 5 is a block diagram illustrating a system for generating conversational outputs to user queries requesting user-specific information, in accordance with example embodiments.

FIG. 6 illustrates conversational user queries and corresponding conversational outputs, in accordance with example embodiments.

FIG. 7 is a block diagram illustrating an architecture for generating conversational outputs to user queries requesting user-specific information, in accordance with example embodiments.

FIG. 8 is a flow chart illustrating a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example System and Device Architecture

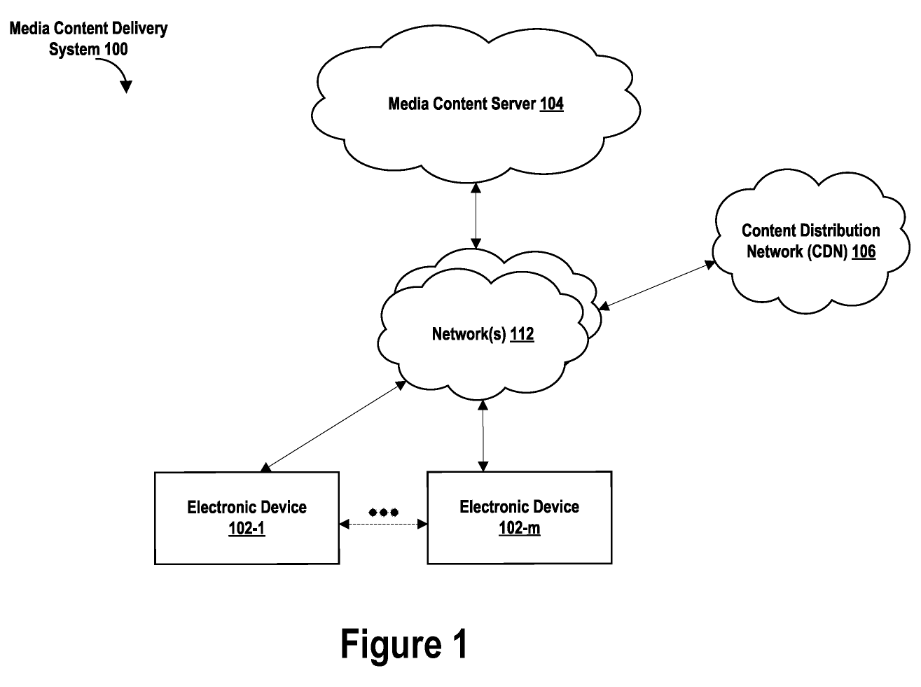

FIG. 1 is a simplified block diagram illustrating an example media content delivery system 100. The example media content delivery system 100 includes one or more electronic devices 102 (e.g., electronic device 102-1 to electronic device 102-m, where m is an integer greater than one), at least one media content server 104, and at least one content distribution network (CDN) 106. With this arrangement, the media content server 104 may be configured to stream or otherwise provide media content items, possibly through the CDN 106, for receipt and playout by the electronic devices 102.

Media content items (also referred to as “media content”, “content”, “media items”, and “content items”) may take various forms. For instance, the media content items may include audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2D or 3D graphics-based computer games, etc.), web pages, and/or any combination of these and/or other types of content. In some embodiments, media content items may include one or more audio media content items, such as particular songs, podcasts, or audiobooks, that may be referred to as “audio items,” “tracks,” and/or “audio tracks”.

As shown, one or more networks 112 may communicatively couple the components of the media content delivery system 100. The one or more networks 112 may include public communication networks, private communication networks, or a combination of both public and private communication networks. For example, the one or more networks 112 could include one or more wide area networks (WANs) such as the Internet, a cellular network, and a satellite communication network, and/or could include one or more local area networks (LAN), virtual private networks (VPN), metropolitan area networks (MAN), peer-to-peer networks, mesh networks, and/or ad-hoc connections, among other possibilities.

Example electronic devices 102, which may be associated respectively with one or more users, may take various forms. For instance, an electronic device 102 could be a personal computer, a mobile electronic device, a wearable computing device, a laptop computer, a tablet computer, a mobile phone, a feature phone, a smartphone, an infotainment system, a digital media player, a gaming device, a speaker, a television (TV), and/or any other electronic device capable of playing and/or presenting media content (e.g., controlling playback of media items, such as music tracks, podcasts, videos, etc.) Alternatively, the electronic device 102 may be a component of another system such as a home entertainment system, a radio/alarm clock, or an infotainment system of a vehicle, for instance, and may enable that system to play media content.

In some embodiments, the electronic devices 102 may be the same type of device as each other (e.g., electronic device 102-1 and electronic device 102-m are both speakers). In other embodiments, the electronic devices 102 may include two or more different types of devices.

The example electronic devices 102 may also be configured to communicate with each other through direct or networked communication links, represented by the dashed arrow in FIG. 1, which may include wireless and/or wired connections. For instance, the electronic devices 102 may communicate with each other through a direct wired connection such as a High Definition Multimedia Interface (HDMI) connection, or through a direct wireless communication such as short or medium range wireless signaling using technologies such as BLUETOOTH, BLUETOOTH LOW ENERGY (BLE), ZIGBEE, WI-FI, WIRELESSHART, Near Field Communication (NFC), Radio Frequency Identification (RFID), infrared, Thread, Z-Wave, MiWi, Low-Rate Wireless Personal Area Network (LR-WPAN), or Internet Protocol v. 6 (IPv6) over WPAN (6oWPAN), among other possibilities. Alternatively or additionally, the electronic devices 102 may communicate with each other through one or more networks (perhaps one or more of network(s) 112), such as through a wireless mesh network, a LAN, a cellular network, or other form of network. Through these inter-device connections, one electronic device 102-1 may stream or otherwise transmit media content to another electronic device 102-m to facilitate playout of the media content.

An example electronic device 102 may be configured to play media content items, outputting the associated media content for presentation to a user and/or outputting the associated media content through an inter-device connection to another electronic device for presentation to a user.

The electronic device 102 may obtain these media content items from local data storage and/or through transmission from the media content server 104, CDN 106, or other device or system. For instance, the electronic device 102 may include or otherwise have access to local data storage containing some of these media content items and may be configured to retrieve the media content items from that local data storage and to play out the retrieved media content items. Further the electronic device 102 may be configured to interwork with the media content server 104 to cause the media content server 104 to stream, progressively download, and/or otherwise transmit media content items to the electronic device 102, and the electronic device 102 may be configured to receive and play out those transmitted media content items as well. In some cases, an example electronic device 102 may also be configured to transmit to the media content server 104 indications of media content items, possibly the media content items themselves, for various purposes.

To facilitate playout of media content items, the example electronic device 102 may be programmed with a media application. The media application may provide a user interface (e.g., a graphical user interface (GUI)) through which a user of the electronic device 102 can control playing of media content items, and the media application may include a media-playback engine configured to obtain and play out media content items in response to user control commands and/or other triggers.

For instance, the media application may receive a user’s control commands related to playout of media content items, such as requests to play particular media content items or playlists of media content items and commands to pause or stop media playout, to adjust volume, or to jump to a next track or a previous track, among other possibilities. And the media application may be configured to respond to those commands by engaging in associated control signaling with the media content server 104 to control streaming or other transmission of media content items from the media content server 104 to the electronic device 102 and/or by engaging in associated control of playing out media content items from local data storage.

An example media content server 104 may be configured to receive media commands or other requests from electronic devices 102 and to respond accordingly. To facilitate this, in some embodiments, the media content server 104 may provide an application programming interface (API), such as a voice API or a connect API, accessible by one or more of the electronic devices 102. The media content server 104 may also be configured to validate (e.g., authenticate) electronic devices 102 using a key service, such as by exchanging one or more keys (e.g., tokens) with the electronic device 102.

The example media content server 104 may include or otherwise have access to data storage storing media content items available for transmission to electronic devices 102, as well as playlists each defining a sequence or other set of media content items for playout. Playlists may be defined by users of the electronic devices 102, by editors associated with media-providing services, and/or by machine-based processes, among other possibilities. The media content server 104 may also be configured to provide electronic devices 102 with information about the available media content items and playlists, such as web pages or other interfaces presenting the information, to enable users of the electronic devices 102 to obtain this information and to correspondingly control media playout.

Further, in some implementations, the media content server 104 may interwork with the one or more CDNs 106 to facilitate management and transmission of media content items and associated information to the electronic devices 102. For instance, a CDN 106 may cache media content items, playlists, and associated data and may be configured to transmit this data to electronic devices 102 through the network(s) 112 in response to requests from the electronic devices.

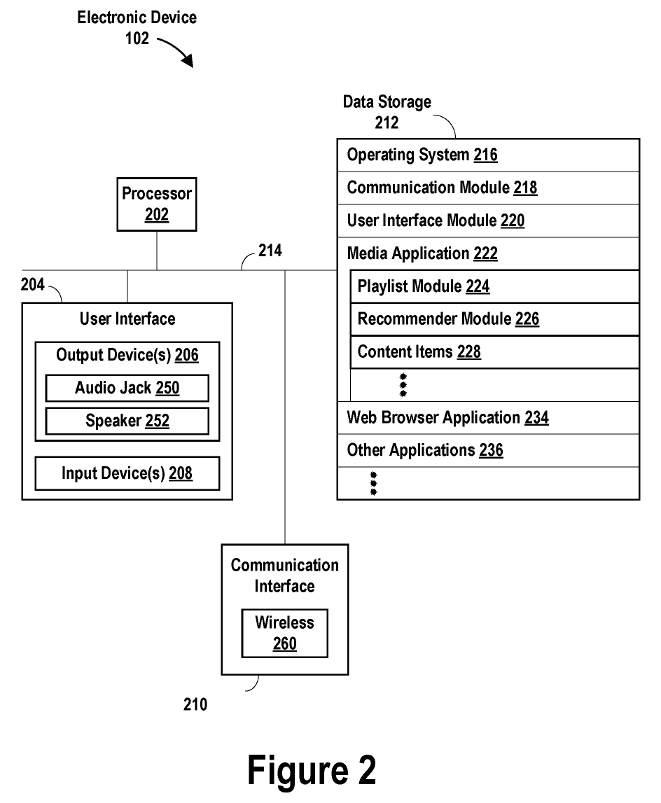

FIG. 2 is simplified a block diagram illustrating an example electronic device 102. As shown in FIG. 2, the example electronic device 102 includes a processor 202, a user interface 204, a communication interface 210, and non-transitory data storage 212, any or all of which may be integrated together to various extents and/or communicatively linked with each other by a system bus, network, or other connection mechanism 214, on a chipset or other integrated circuit, among other possibilities.

The processor 202 may include one or more general purpose processors (e.g., microprocessors) and/or one or more specialized processors (e.g., digital signal processors (DSPs), graphics processing units (GPUs), neural processing units (NPUs), etc.).

The user interface 204 may include one or more output devices 206 and one or more input devices 208 to facilitate interaction with a user. Example output devices 206 may include audio output devices such as an audio jack 250, a sound speaker 252, and/or another port or the like for connecting with speakers, earbuds, headphones, and/or other listening devices, and video output devices, such as a display panel for instance. Further, example input devices 208 may include an audio input device such as a microphone and other types of user input mechanisms such as a touch-sensitive panel, a keyboard or keypad, and/or a mouse or trackpad, among other possibilities. In some embodiments, the user interface may support voice input, and the electronic device 102 may include or interact with a voice recognition system to facilitate processing of voice input from a user.

The communication interface 210 may include one or more components to facilitate communicating with other electronic devices 102, with the media content server 104, with the CDN 106, with associated media presentation systems, and/or with other devices and/or systems. For instance, the communication interface 210 may include one or more wireless communication interfaces 260 configured to facilitate direct or networked communication according to any of various wireless communication protocols, such as those noted above, among others. In addition or alternatively, the communication interface 210 may include one or more wired communication interfaces supporting direct or networked communication according to any of various wired communication protocols, such as HDMI, Universal Serial Bus (USB), THUNDERBOLT, and/or Ethernet, among others.

The non-transitory data storage 212 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor 202 or may be provided separately. As further shown, the data storage 212 may store program instructions, which may be executable by the processor 202 to carry out various electronic device operations.

These instructions may define programs, modules, and/or data structures, such as but not limited to an operating system 216, a communication module 218, a user interface module 220, a media application 222, a web browser application 234, and one/or more other applications 236. Further, these instructions may be structured as separate software programs, procedures, modules, or the like, and/or may be combined together and/or otherwise arranged in various embodiments.

The operating system 216 may define procedures for handling various basic system services and for performing hardware-dependent tasks. The communication module 218 may define procedures supporting connection and communication with other computing devices and systems (e.g., with the media content server 104, the CDN 106, with various media presentation systems, and/or with other electronic devices 102) through the communication interface 210 and possibly the one or more networks 112. And the user interface module 220 may define procedures supporting use of the user interface 204, such as to receive commands and/or other input from a user and to provide media playback and other output to the user.

In line with the discussion above, the media application 222 may be a program application configured to access a media-providing service of a media-content provider associated with the media content server 104 for instance, and may be configured to support requesting, receiving, processing, and presenting of media content items. In some implementations, the media application 222 may include a media-player, a streaming-media application, and/or any other appropriate application or component to facilitate retrieval and/or receipt of media content and playing of the media content. Further, the media application 222 may be configured to monitor, store, and/or transmit (e.g., to the media content server 104) data associated with user behavior, with user permission. Further, the media application 222 may define various logic modules, such as a playlist module 224, a recommender module 226, and/or a content-items module 228.

The playlist module 224 may store sets of media items for playback in a predefined order. Further, the playlist module 224 may be configured to generate playlists. In some embodiments, the playlist module 224 may include a diffusion-model component, a large-language-model component, and/or a nearest-neighbor-search component, among other possibilities. The recommender module 226 may be configured to identify and/or display recommended media content items (e.g., for inclusion in a playlist). The recommender module 226 may likewise include a diffusion-model component, a large-language-model component, and/or a nearest-neighbor-search component, among other possibilities. The content-items module 228 may be configured to store media content items, including audio items such as songs, podcasts, and audiobooks, for playback, and to provide requests for media content items to the media content server 104. In some implementations, the content-items module 228 may include or otherwise have access to a set of vector representations for the media content items.

The web browser application 234 may be configured to support user access, viewing, and interaction with web sites. To facilitate this, the web browser application 234 may be configured to use standard web-based communication protocols, web-based applications, and/or web-based content formats and/or may be configured to use proprietary protocols, applications, and formats.

The other applications 236 in the non-transitory data storage 212 of the electronic device 102 may then include any of a variety of additional applications, supporting operations such as word processing, calendaring, mapping, weather, time keeping, virtual digital assistant, presenting, drawing, instant messaging, e-mail, telephony, video conferencing, photo management, video management, music playing, video playing, 2D gaming, 3D (e.g., virtual reality) gaming, electronic book reading, and/or workout management, among other possibilities.

The example electronic device 102 may also include one or more sensors (not shown) such as accelerometers, gyroscopes, compasses, magnetometer, light sensors, near field communication transceivers, barometers, humidity sensors, temperature sensors, proximity sensors, range finders, and/or other devices for sensing and measuring various operational, environmental and/or other conditions, among possibly other components.

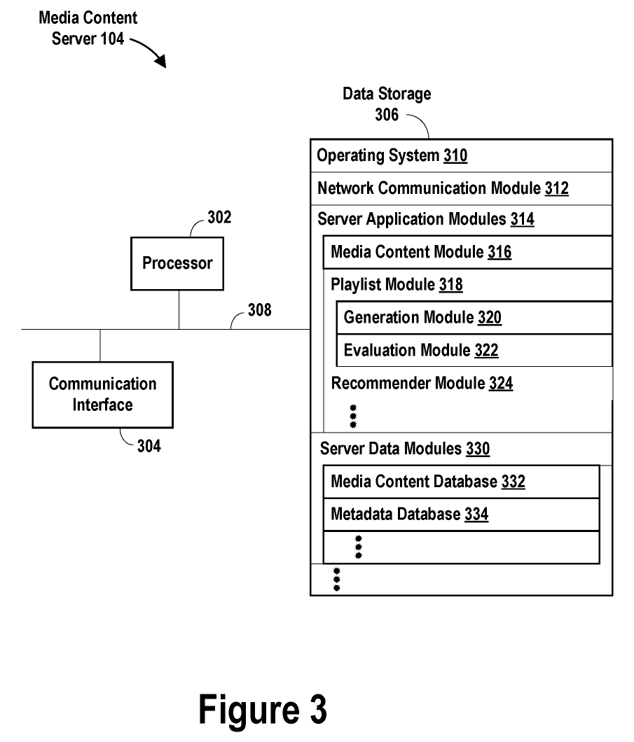

FIG. 3 is next a simplified block diagram of an example media content server 104. As shown in FIG. 3, the example media content server 104 includes a processor 302, a communication interface 304, and non-transitory data storage 306, any or all of which may be integrated together to various extents and/or communicatively linked with each other by a system bus, network, or other connection mechanism 308, on a chipset or other integrated circuit, among other possibilities.

The processor 302 may include one or more general purpose processors (e.g., microprocessors) and/or one or more specialized processors (e.g., DSPs, GPUs, NPUs, etc.).

The communication interface 304 may comprise a network communication interface to facilitate communicating with the electronic devices 102 and the CDN 106 through the one or more networks 112. For instance, the communication interface 304 may include a wired and/or wireless Ethernet communication module, among other possibilities.

The non-transitory data storage 306 may include one or more volatile and/or non-volatile storage components (e.g., flash, optical, magnetic, ROM, RAM) (e.g., DRAM, SRAM, or DDRAM), EPROM, and/or EEPROM, etc.), which may be integrated in whole or in part with the processor 302 or may be provided separately. As further shown, the data storage 306 may store program instructions, which may be executable by the processor 302 to carry out various media-content-server operations.

These instructions may define programs, modules, and/or data structures, such as but not limited to an operating system 310, a network communication module 312, one or more server application modules 314, and one or more server data modules 330. Further, these instructions may be structured as separate software programs, procedures, modules, or the like, and/or may be combined together and/or otherwise arranged in various embodiments.

The operating system 310 may define procedures for handling various basic system services and for performing hardware-dependent tasks. And the communication module 312 may define procedures supporting connection and communication with other computing devices and systems, such as with the electronic devices 102 and the CDN 106, through the communication interface 304 and possibly through the one or more networks 112.

The one or more server application modules 314 may define procedures supporting providing and managing a content service. These server application modules 314 may include a media content module 316, a playlist module 318, and/or a recommender module 324, among other possibilities.

The media content module 316 may store and/or otherwise have access to media content items and may be configured to send (e.g., stream and/or progressively transmit) the media content items to the electronic devices 102. The playlist module 318 may store and/or otherwise have access to data defining sequences or other sets of media content items and may be configured to send those playlists to the electronic devices 102. The playlist module 318 may include a generation module 320 for generating playlists and media sets, and an evaluation module 322 for evaluating the playlists and media sets, e.g., before and after publication. Further, the playlist module 318 may include a diffusion-model component, a large-language-model component, and/or a nearest-neighbor-search component, among other possibilities.

The recommender module 324 may determine and/or provide media-content- item recommendations (e.g., for a playlist). In some embodiments, the recommender module 324 also includes a diffusion-model component, a large-language-model component, and/or a nearest neighbor-search component, among other possibilities.

The one or more server data modules 330 may manage the storage of and/or access to media items and/or metadata relating to media content items. As such, the one or more server data modules 330 may include a media content database 332 for storing media items and/or vector representations (e.g., vector embeddings) of the media content items, and a metadata database 334 for storing metadata relating to the media content items, such as genre, artist, and other information associated with the respective media content items.

The media content server 104 may also include a web server such as a Hypertext Transfer Protocol (HTTP) servers, File Transfer Protocol (FTP) servers, and may maintain or otherwise have access to web pages and other content defined with Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

The description of the media content server 104 as a “server” is intended as a functional description of the devices, systems, processor cores, and/or other components that provide the functionality attributed to the media content server 104. It will be understood that the media content server 104 may be a single server computer, or may comprise multiple server computers. Moreover, the media content server 104 may be coupled with CDN 106 and/or other servers and/or server systems, or other devices, such as other client devices, databases, content delivery networks (e.g., peer-to-peer networks), network caches, and the like. Further, in some embodiments, the media content server 104 may be implemented by multiple computing devices working together to perform the actions of a server system, such as to provide cloud-based server or cloud-computing service.

### II. Digital Audio Content and Streaming

Digital audio content may encompass a broad range of audio data that has been converted into a digital format, enabling it to be stored, processed, transmitted, and received by electronic devices. By way of example, digital audio content could include songs and other music, as well as spoken word recordings such as news broadcasts, podcasts, audiobooks, that offer listeners a convenient way to consume information and entertainment through auditory means. Further, digital audio content could combine spoken word with music or other sounds, creating rich, multi-layered audio experiences suitable for radio shows, multimedia presentations, and enhanced podcasts. And still further, digital audio content could constitute the audio portion of multimedia video content (e.g., of H.264/MPEG-4 or 3GP encoded content), such as the soundtrack of a movie, television show, online video, or live stream, among many other possibilities.

Digital audio content represents analog audio content as a sequence of digital information such as a bits representing sequential frames of the analog audio. Digital audio content may be compressed or otherwise encoded using various encoding techniques (e.g., MP3, AAC, or Opus) to help reduce file size while maintaining quality and to help facilitate distribution of the audio through various techniques such as streaming, progressive downloading, bulk file transfer, or broadcasting, for instance.

Digital audio streaming involves transmitting a digital audio stream from a content source (e.g. media content server 104 or CDN 106) to an electronic device 102, typically over a network 112, for real-time playout of the audio by the electronic device 102 as the electronic device 102 receives the transmission. A variation of audio streaming is progressive downloading, where an electronic device 102 downloads a digital audio file in pieces and plays out the audio file before the entire download is finished. One technical difference between streaming and progressive downloading is that, with streaming, the electronic device 102 usually does not maintain a copy of the audio as the electronic device 102 plays it out, whereas with progressive downloading, the electronic device 102 ends up with a downloaded copy of the audio for possible later playout as well.

To prepare digital audio for streaming or other distribution, a computing system such as the media content server 104 may start with a digital audio file that defines a time sequence of digital audio data such as a sequence of audio frames, the computing system may encode the digital audio data of the file using an encoding algorithm to establish a corresponding time sequence of encoded digital audio data, and the computing system may segment the encoded digital audio data into smaller pieces or audio segments, which the computing system may store for transmission. Further, the computing system may generate multiple different encoded versions of the digital audio segments per file, using multiple different levels or types of encoding and compression, to facilitate adaptive switching between versions during transmission.

To facilitate streaming of an audio content item to an electronic device 102, the media content server 104 may employ a streaming protocol such as HTTP Live Streaming (HLS), Dynamic Adaptive Streaming over HTTP (DASH), or Real-Time Messaging Protocol (RTMP) to transmit the audio segments. These protocols manage the data transmission and adapt to varying network conditions. Additionally, the media content server 104 may handle user sessions, managing requests for specific audio streams and providing secure access through authentication and authorization mechanisms. The media content server 104 may also make use of the CDN 106, which may cache the audio content pieces on geographically distributed servers, to help reduce streaming latency and improve reliability and user experience.

On the receiving end, the media application 222 of the electronic device 102 may initiate a connection to the media content server 104 and request streaming of a specific audio content item. As the media application 222 receives the initial audio segments of the requested audio content in response to this request, the media application 222 may then start buffering and pre-loading a portion of the audio in the memory of the electronic device 102 to facilitate smooth playback even in the case of minor network interruptions. Further, the media application 222 may decode the audio pieces in order to uncover the original digital audio data and may convert that digital audio data to a form suitable for output. For instance, the media application 222 may play the decoded audio through an audio output device 206 of the electronic device 102 or through another electronic device 102. Further, the media application 222 may manage playback (e.g., play, pause, skip, and volume adjustment) through associated user-interface controls.

Adaptive streaming protocols such as those discussed above may allow the electronic device 102 to monitor network conditions and request different quality levels of digital audio content based on current bandwidth availability, thus providing consistent playback without interruptions in most cases. Further, the electronic device 102 may handle network errors and interruptions by attempting to reconnect to the media content server 104, by re-buffering when necessary, and by dynamically adjusting the stream quality to maintain a continuous audio experience.

### III. Example Device

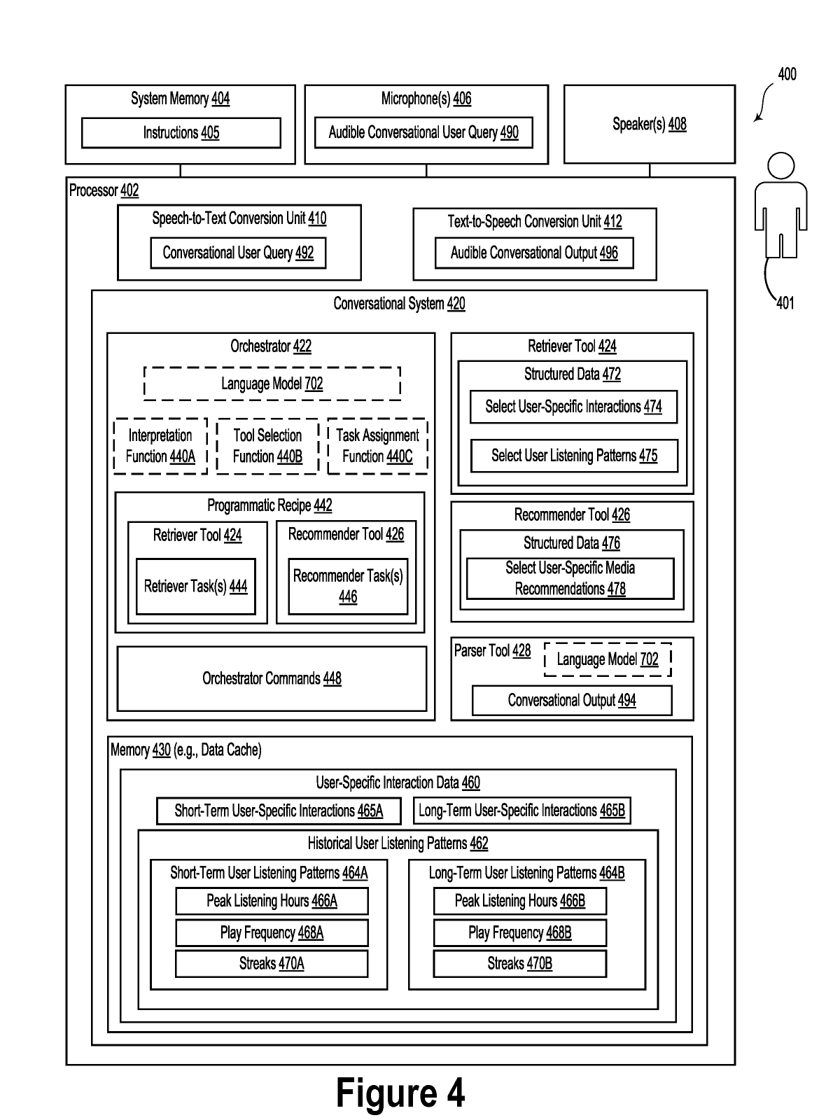

FIG. 4 is a block diagram illustrating a device 400, in accordance with some embodiments. In some embodiments, the device 400 may be a media playback device. In some embodiments, some components of the device 400 may be integrated into a media server, and other components of the device 400 may be integrated into a media playback device. As described below, the device 400 may be configured to generate conversational outputs to conversational user queries that request personalized information associated with a streaming media platform.

The device 400 includes one or more processors 402 (herein referred to as “the processor 402”), a system memory 404 coupled to the processor 402, one or more microphones 406 (herein referred to as “the microphone 406”) coupled to the processor 402, and one or more speakers 408 (herein referred to as “the speaker 408”) coupled to the processor 402. In some embodiments, the processor 402 can correspond to the processor 202 of FIG. 2 or the processor 302 of FIG. 3. In some embodiments, each component of the device 400 may be integrated into a media playback device, such as the electronic device 102. In other embodiments, the microphone 406 and the speaker 408 may be integrated into a media playback device, and the system memory 404 and the processor 402 may be integrated into a media server, such as the media content server 104. In these embodiments, one or more communication interfaces may be used to communicate data between the media playback device and the media server.

The system memory 404 may be a non-transitory computer-readable medium that includes instructions 405 executable by the processor 402 (or a conversational system 420 hosted by the processor 402) to perform the operations described herein. In some embodiments, the system memory 404 may include high-speed random-access memory, such as DRAM, SRAM, DDR RAM, or other random-access solid-state memory devices. In some embodiments, the system memory 404 may include non-volatile memory, such as one or more magnetic disk storage devices, optical disk storage devices, flash memory devices, or other non-volatile solid-state storage devices. In some embodiments, the system memory 404 may include one or more storage devices remotely located from the processor 402.

The processor 402 includes a speech-to-text conversion unit 410, a text-to-speech conversion unit 412, and a conversational system 420. In some embodiments, one or more components of the processor 402 may be implemented using dedicated circuitry. As non-limiting examples, one or more components of the processor 402 may be implemented using one or more application-specific integrated circuits (ASICs) and/or one or more field-programmable gate array (FPGA) devices. In some embodiments, one or more components of the processor 402 may be implemented using software. As a non-limiting example, to perform functions associated with one or more components of the processor 402, the processor 402 may execute the instructions 405 stored in the system memory 404.

The microphone 406 may be configured to detect an audible conversational user query 490 from a user 401 of the device 400. The audible conversational user query 490 may request user-specific information (e.g., personalized information) associated with a streaming media platform. As a non-limiting example, the microphone 406 may detect the user 401 stating “If my listening history were turned into a festival, which artists would be on the lineup”. Thus, in the above scenario, the audio conversational user query 490 is requesting a hypothetical festival lineup based on the user’s 401 listening history. Unless otherwise indicated, for ease of illustration, the above-indicated audio conversation user query 490 is used to describe the operations of the device 400 in FIG. 4. The microphone 406 may provide the audible conversational user query 490 to the speech-to-text conversion unit 410.

The speech-to-text conversion unit 410 may be configured to perform a speech-to-text conversion operation on the audible conversational user query 490 to generate a conversational user query 492. The conversational user query 492 may be a textual version of the audible conversational user query 490. Thus, the conversational user query 492 may include the text “If my listening history were turned into a festival, which artists would be on the lineup”. The speech-to-text conversion unit 410 may provide the conversational user query 492 to the conversational system 420.

The conversational system 420 includes an orchestrator 422, a retriever tool 424, a recommender tool 426, a parser tool 428, and a memory 430 (e.g., a data cache). In some embodiments, components of the conversational system 420 may be utilize a language model 702, such as a LLM. For example, the orchestrator 422 and the parser tool 428 may be part of (or utilize) the language model 702, and the retriever tool 424 and the recommender tool 426 may operate as plug-in components to the language model 702.

The orchestrator 422 may be configured to receive the conversational user query 492 from the speech-to-text conversion unit 410. The orchestrator 422 may be configured to perform an interpretation function 440A on the conversational user query 492. In some embodiments, the orchestrator 422 may utilize the language model 702 to interpret (e.g., understand) the conversational user query 492. In other embodiments, the interpretation function 440A may use natural language processing to interpret and/or understand task(s) conversational user query 492. In particular, the interpretation function 440A may be performed to identify different tasks 444, 446 required to process the conversational user query 492. To illustrate, using the above example where the conversational user query 492 inquires which artist would be on a festival lineup if the user’s 401 listening history was turned into a festival, the interpretation function 440A may be used to identify one or more tasks 444, 446 for determining which artist would be on the festival lineup. As a non-limiting example, the tasks 444, 446 may include (i) analyzing a listening history of the user 401, (ii) identifying each artist the user 401 has listened to within a particular time period, (iii) identifying a frequency that the user 401 has listened to each artist, (iv) determining which genre of music the user 401 has most frequently listened to during within the particular time period, (v) recommending popular music artist associated with the genre of music, etc.

The orchestrator 422 may also be configured to perform a tool selection function 440B. The tool selection function 440B enables the orchestrator 422 to select one or more tools capable of performing the tasks 444, 446 identified by the orchestrator 422. For example, the orchestrator 422 may select the retriever tool 424 and the recommender tool 426 to perform the tasks 444, 446 identified by the orchestrator 422.

The orchestrator 422 may also be configured to perform a task assignment function 440C. The task assignment function 440C enables the orchestrator 422 to assign different tasks 444, 446 to the selected tools 424, 426. For example, the orchestrator 422 may assign a first subset of the tasks 444 to the retriever tool 424 and a second subset of the tasks 446 to the recommender tool 426.

Using the interpretation function 440A, the tool selection function 440B, and the task assignment function 440C, the orchestrator 422 may be configured to generate a programmatic recipe 442 for processing the conversational user query 492. The programmatic recipe 442 may specify one or more of (i) how the retriever tool 424 is to be used in processing the conversational user query 492 and (ii) how the recommender tool 426 is to be used in processing the conversational user query 492. For example, as illustrated in FIG. 4, the programmatic recipe 442 for processing the conversation user query 492 may indicate one or more retriever tasks 444 for the retrieval tool 424 and one or more recommender tasks 446 for the recommender tool 426.

Based on the programmatic recipe 442, the orchestrator 422 may generate orchestrator commands 448 that instruct (i) the retriever tool 424 to perform the retriever tasks 444 and/or (ii) the recommender tool 426 to perform the recommender tasks 446. The orchestrator commands 448 are provided to the retriever tool 424 and to the recommender tool 426.

In response to receiving the orchestrator commands 448, the retriever tool 424 may be configured to perform the one or more retriever tasks 444 indicated in the programmatic recipe 442. In the example used herein where the conversational user query 492 is requesting a hypothetical festival lineup based on the user’s 401 listening history, the retriever tasks 444 may include (i) analyzing a listening history of the user 401, (ii) identifying each artist the user 401 has listened to within a particular time period, (iii) identifying a frequency that the user 401 has listened to each artist, and (iv) determining which genre of music to which the user 401 has most frequently listened during within the particular time period.

To perform the retriever tasks 444, the retriever tool 424 may be configured to access the memory 430 that stores information indicative of user-specific interactions 465 with the streaming media platform. For example, as illustrated in FIG. 4, the memory 430 may store user-specific interaction data 460 that indicates user-specific interactions 465 and historical user listening patterns 462. The historical user listening patterns 462 may be derived based on a logging of the user-specific interactions 465.

The user-specific interactions 465 may include short-term user-specific interactions 465A and long-term user-specific interactions 465B. Generally, user-specific interactions 465 may include any interactions between the user 401 and the streaming media platform. As non-limiting examples, user-specific interactions 465 may indicate (i) artists to which the user 401 has selected to listen, (ii) media content to which the user 401 has left feedback (e.g., clicked a “like” button, clicked a “dislike button, left a positive comment, left a negative comment, shared, clicked a “not interested” button, etc.), (iii) genres of music the user 401 has selected for playback, (iv) media content the user 401 has selected for playback, (v) media content the user 401 skipped, etc. In some examples, the short-term user-specific interactions 465A may include user-specific interactions 465 within the past two (2) months, and the long-term user-specific interactions 465B may include user-specific interactions 465 within the past year. It should be understood that the time period to classify user-specific interactions 465 as short-term and long-term are merely for illustrative purposes and, in other embodiments and/or examples, the time period to classify user-specific interactions 465 as short-term and long-term may be different. In some embodiments, the time period to classify user-specific interactions 465 as short-term and long-term may be user-configurable.

The historical user listening patterns 462 include short-term user listening patterns 464A for a first time period and long-term user listening patterns 464B for a second time period that includes the first time period. As a non-limiting example, the short-term user listening patterns 464A may indicate listening patterns within the past two (2) months, and the long-term user listening patterns 464B may indicate listening patterns within the past year. It should be understood that the time period to classify listening patterns 464 as short-term and long-term are merely for illustrative purposes and, in other embodiments and/or examples, the time period to classify listening patterns 464 as short-term and long-term may be different. In some embodiments, the time period to classify listening patterns 464 as short-term and long-term may be user-configurable.

The short-term user listening patterns 464A may indicate peak listening hours 466A during the first time period, a play frequency 468A during the first time period, and streaks 470A during the first time period. The long-term user listening patterns 464B may indicate peak listening hours 466B during the second time period, a play frequency 468B during the second time period, and streaks 470B during the second time period. It should be understood that, in some embodiments, the user listening patterns 464A, 464B may indicate additional and/or different user listening patterns and tendencies.

Upon accessing the memory 430, in some embodiments, the retriever tool 424 may be configured to generate at least a part of structured data 472 representing select user-specific interactions 474 with the streaming media platform. The select user-specific interactions 474 may include any user-specific interactions 465 that are relevant to the conversational user query 492. In some embodiments, the orchestrator 422 may indicate, in the programmatic recipe 442, which user-specific interactions 465 are relevant to the conversational user query 492. In particular, the orchestrator commands 448 provided to the retriever tool 424 may indicate which type of user-specific interactions 465 are relevant to the conversational user query 492. As a non-limiting example, the orchestrator commands 448 may indicate that the select user-specific interactions 474 should include (i) artists to which the user 401 has selected to listen during a particular time period (e.g., the short-term time period, the long-term time period, or both) and (ii) genres of music the user 401 has selected for playback during the particular time period.

In some embodiments, in generating the structured data 472, the short-term user-specific interactions 465A may be weighted differently than the long-term user-specific interactions 465B. For example, the retriever tool 424 may assign (i) a first weight to the short-term user-specific interactions 465A to generate a first user-specific interaction subset of the structured data 472 and (ii) a second weight to the long-term user-specific interactions 465B to generate a second user-specific interaction subset of the structured data 472. The first weight may be greater than the second weight such that recent user-specific interactions 465 are weighted heavier than other user-specific interactions 465. With respect to the user-specific interactions 465, the structured data 472 may include the first subset and the second subset.

Additionally, or in the alternative, upon accessing the memory 430, in some embodiments, the retriever tool 424 may be configured to generate at least a part of the structured data 472 representing select user listening patterns 475. The select listening patterns 475 may include any historical user listening patterns 462 that are relevant to the conversational user query 492. In some embodiments, the orchestrator 422 may indicate, in the programmatic recipe 442, which historical user listening patterns 462 are relevant to the conversational user query 492. As a non-limiting example, the orchestrator commands 448 may indicate that the select user listening patterns 475 should include the play frequency 468 and the streaks 470.

In some embodiments, in generating the structured data 472, the short-term user listening patterns 464A may be weighted differently than the long-term user listening patterns 464B. For example, the retriever tool 424 may assign (i) a first weight to the short-term user listening patterns 464A to generate a first listening pattern subset of the structured data 472 and (ii) a second weight to the long-term user listening patterns 464B to generate a second listening pattern subset of the structured data 472. The first weight may be greater than the second weight such that recent user listening patterns 462 are weighted heavier than other user listening patterns 462. With respect to the user listening patterns 462, the structured data 472 may include the first subset and the second subset.

In response to receiving the orchestrator commands 448, the recommender tool 426 may be configured to perform the one or more recommender tasks 446 indicated in the programmatic recipe 442. In some embodiments, the recommender tasks 446 may include recommending one or more media content items and/or artists on the streaming media platform. The recommended media content items and/or artist may be based on previously accessed media content items. Thus, in some embodiments, to perform the recommender tasks 446, the recommender tool 426 may (i) access the memory 430 to identify previously accessed media content items (e.g., user-specific interactions 465) and/or (ii) communicate with the retriever tool 424 to identify previously accessed media content items.

In some embodiments, the recommender tool 426 may be configured to communicate with one or more recommendation systems 550 of the streaming media platform, such as the recommender module 324, to recommend one or more media content items and/or artists. For example, the recommender tool 426 may utilize an API call to a media library of the streaming media platform to identify different music/artists recommended for the user 401. In particular, the recommender tool 426 may prompt a recommendation system 550 integrated into the streaming media platform to recommend one or more media content items/or artist on the streaming media platform. In these embodiments, the recommendations systems 550 may have access to the user-specific interactions 465 and may generate the recommendations based on the user-specific interactions 465.

The recommender tool 426 may be configured to generate structured data 476 representing select user-specific media recommendations 478 associated with the streaming media platform. As referenced above, the select user-specific media recommendations 478 may be generated by the recommender tool 426 directly or by a recommendation system integrated into the streaming media platform. In the example used herein where the conversational user query 492 is requesting a hypothetical festival lineup based on the user’s 401 listening history, the recommender tasks 446 may include recommending a popular music artist associated with a genre of music the user 401 has commonly selected for playback. Thus, in this example, the recommender tasks 446 may be dependent on the genre identified by the retriever tool 424 during performance of the retriever tasks 444.

The structured data 472 generated from the retriever tool 424 and the structured data 476 generated from the recommender tool 426 may be provided to the parser tool 428. The parser tool 428 may be configured to generate a conversational output 494 based on the structured data 472 and the structured data 476. For example, where the conversational user query 492 is requesting a hypothetical festival lineup based on the user’s listening history, the parser tool 428 may generate the conversational output 494 to offer suggestions of artists that would be on the lineup. To illustrate, the conversational output 494 may include text that states “Artist X and Artist Y would definitely headline any musical festival that was created based on your musical taste, and Artist Z would likely be the opening act.” To generate the conversational output 494, the parser tool 428 may utilize the language model 702. For example, the structured data 472, 476 may be provided as an input to the language model 702, and the language model 702 may output the conversational output 494.

The conversational output 494 may be provided to the text-to-speech conversion unit 412. The text-to-speech conversion unit 412 may be configured to perform a text-to-speech conversation operation on the conversational output 494 to generate an audible conversational output 496. The audible conversational output 496 may be output by the speaker 408.

The techniques described with respect to FIG. 4 enable streaming media platforms to provide personalized conversational interactions with the user 401 based on user preferences. For example, the conversational system 420 may generate the conversational output 494 to the conversational user query 492 based on user-specific information (e.g., listening patterns 464 and interactions 465). As a result, user experience may be enhanced such that the user 401 feels as if he or she is having a conversation. For example, and as further described with respect to FIG. 3, the format of the conversational output 494 can vary based on the context of the conversational user query 492. To illustrate, the conversational output 494 can be used to poke fun of the user’s 401 listening taste, create a hypothetical festival lineup for the user 401, provide thoughtful analysis of the user’s 401 listening history, etc.

To generate the conversational output 494, the orchestrator 422 uses a language model to (i) interpret (e.g., understand) the conversational user query 492 and (ii) generate the programmatic recipe 442 that defines the different agents (e.g., tools 424, 426) involved with processing the conversational user query 492. The retriever tool 424 may fetch and analyze the user’s 401 listening history (e.g., tracks, artists, genres, etc.) and may access the memory 430 (e.g., a long-term memory module) that detects user listening patterns 464 for an accurate temporal analysis. The recommender tool 426 provides contextualized music suggestions via recommendations services available to the streaming media platform. The parser tool 428 converts the structured data 472, 476 (e.g., structured metadata) collected through the retriever and recommender tools 424, 426 into the conversational output 494 using a language model.

### IV. Example System

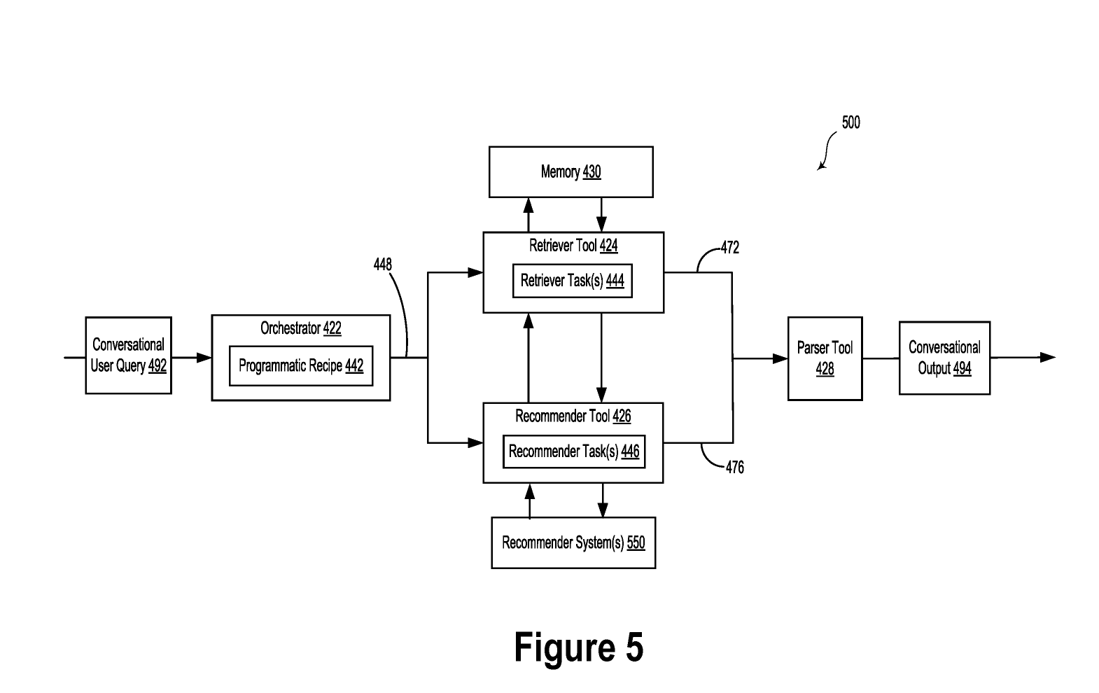

FIG. 5 is a diagram illustrating a system 500, in accordance with some embodiments. In some embodiments, components of the system 500 may be integrated into the device 400 described with respect to FIG. 4. For example, the system 500 includes the orchestrator 422, the retriever tool 424, the recommender tool 426, the parser tool 428, and the memory 430.

According to the system 500, the conversational user query 492 is provided to the orchestrator 422. The orchestrator 422 may generate the programmatic recipe 442 for processing the conversational user query 492. The programmatic recipe 442 may specify one or more of (i) how the retriever tool 424 is to be used in processing the conversational user query 492 and (ii) how the recommender tool 426 is to be used in processing the conversational user query 492. Based on the programmatic recipe 442, the orchestrator 422 generates the orchestrator commands 448 that instruct (i) the retriever tool 424 to perform the retriever tasks 444 and/or (ii) the recommender tool 426 to perform the recommender tasks 446. The orchestrator commands 448 are provided to the retriever tool 424 and to the recommender tool 426.

In response to receiving the orchestrator commands 448, the retriever tool 424 performs the retriever tasks 444 indicated in the programmatic recipe 442. To perform the retriever tasks 444, the retriever tool 424 may be configured to access the memory 430 that stores information indicative of user-specific interactions 465 with the streaming media platform. Upon accessing the memory 430, the retriever tool 424 generates at least a part of the structured data 472 representing select user-specific interactions 474 with the streaming media platform. The select user-specific interactions 474 may include any user-specific interactions 465 that are relevant to the conversational user query 492. In some embodiments, the orchestrator 422 may indicate, in the programmatic recipe 442, which user-specific interactions 465 are relevant to the conversational user query 492. The structured data 472 is provided to the parser tool 428.

In response to receiving the orchestrator commands 448, the recommender tool 426 performs the recommender tasks 446 indicated in the programmatic recipe 442. To perform the recommender tasks 446, the recommender tool 426 may (i) access the memory 430 to identify previously accessed media content items (e.g., user-specific interactions 465) and/or communicate with the retriever tool 424 to identify previously accessed media content items. The recommender tool 426 generates the structured data 476 representing select user-specific media recommendations 478 associated with the streaming media platform. The structured data 472 is provided to the parser tool 428.

The parser tool 428 generates the conversational output 494 based on the structured data 472 and the structured data 476. For example, where the conversational user query 492 is requesting a hypothetical festival lineup based on the user’s 401 listening history, the parser tool 428 may generate the conversational output 494 to offer suggestions of artists that would be on the lineup. To generate the conversational output 494, the parser tool 428 may utilize the language model 702 (e.g., an LLM). For example, the structured data 472, 476 may be provided as an input to the language model 702, and the language model 402 may output the conversational output 494.

### V. Example Conversational Outputs to Conversational User Queries

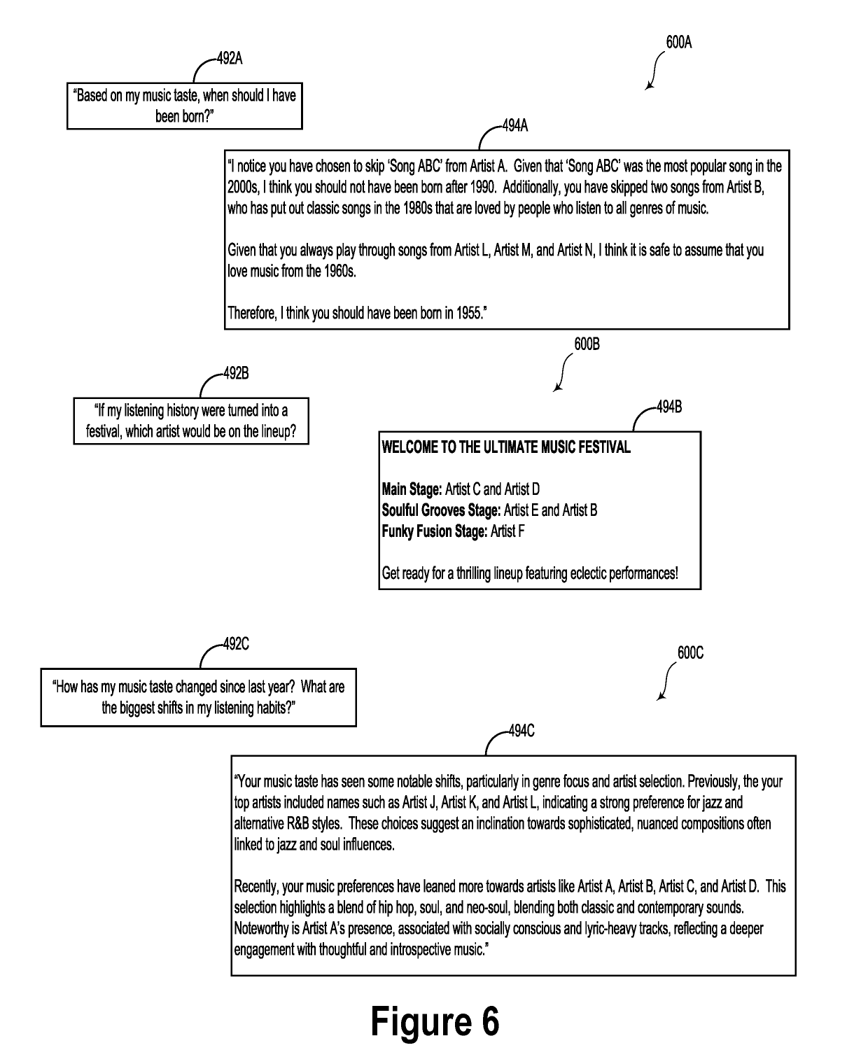

FIG. 6 illustrates different examples 600 of conversational outputs to conversational user queries, in accordance with some embodiments. In particular, FIG. 6 depicts a first example 600A of a conversational user query 492A and a corresponding conversational output 494A, a second example 600B of a conversational user query 492B and a corresponding conversational output 494B, and a third example 600C of a conversational user query 492C and a corresponding conversational output 494C. Each conversational user query 492A, 492B, 492C may be processed using the conversational system 420 to generate the corresponding conversational outputs 494A, 494B, 494C.

In the first example 600A, the conversational user query 492A states “Based on my music taste, when should I have been born?” Thus, in the first example 600A, the user 401 is requesting that the conversational system 420 generate a conversational output 494A that suggests when the user 401 should have been born based on the music he or she likes. The orchestrator 422 may process the conversational user query 492A and generate a programmatic recipe 442 for the conversational user query 492A. For example, in the first example 600A, the orchestrator 422 may generate a programmatic recipe 442 that assigns retriever tasks 444 to the retriever tool 424 to fetch and analyze the user’s 401 music history.

Using the first example 600A in FIG. 6, when performing the retriever tasks 444, the retriever tool 424 may access user-specific interaction data 460 that indicates media content that the user 401 has skipped. For example, the user-specific interaction data 460 may indicate that the user 401 has skipped “Song ABC” by Artist A and two Artist B songs. Additionally, the user-specific interaction data 460 may indicate that the user 401 has played through songs from Artist L, Artist M, and Artist N. The skipped media content and the played through media content can be formatted to into the structured data 472 by the retriever tool 424. The retriever tool 424 may provide structured data 472 to the parser tool 428, and the parser tool 428 may generate the conversational output 494A in the first example 600A. As illustrated in FIG. 6, the conversational output 494A may be formatted in such a manner as to reflect a conversational response by a human being. The parser tool 428 may use the language model 702 to generate the conversational output 494A.

In the second example 600B, the conversational user query 492B states “If my listening history were turned into a festival, which artist would be on the lineup?” Thus, in the second example 600B, the user 401 is requesting that the conversational system 420 generate a festival lineup as a conversational output 494B. The orchestrator 422 may process the conversational user query 492B and generate a programmatic recipe 442 for the conversational user query 492B. For example, in the second example 600B, the orchestrator 422 may generate a programmatic recipe 442 that assigns (i) retriever tasks 444 to the retriever tool 424 to fetch and analyze the user’s 401 music history and (ii) recommender tasks 446 to the recommender tool 426 to recommend different artists based on the user’s 401 music history.

Using the second example 600B in FIG. 6, when performing the retriever tasks 444, the retriever tool 424 may access user-specific interaction data 460 that indicates media content that the user 401 frequently played. For example, the user-specific interaction data 460 may indicate that the user 401 frequently plays music by Artist C and Artist D. The frequency played artist may be formatted into the structured data 472 by the retriever tool 424, and the retriever tool 424 may provide the structured data 472 to the parser tool 428. When performing the recommender tasks 446, the recommender tool 426 may communicate with one or more recommendation systems of the streaming media platform, such as the recommender module 226, to recommend additional artists (e.g., “Artist E, Artist B, and Artist F”) that may interest the user 401. The recommended artists may be formatted into the structured data 476 by the recommender tool 426, and the recommender tool 426 may provide the structured data 476 to the parser tool 428. The parser tool 428 may generate the conversational output 494B in the second example 600B. As illustrated in FIG. 6, the conversational output 494B may be formatted in such a manner as to reflect a music festival lineup created by a human being. The parser tool 428 may use the language model 702 to generate the conversational output 494B.

In the third example 600C, the conversational user query 492C states “How has my music taste changed since last year? What are the biggest shifts in my listening habits?” Thus, in the third example 600C, the user 401 is requesting that the conversational system 420 generate a conversational output 494C compares his or her recent music tastes to his or her music taste from a year ago. The orchestrator 422 may process the conversational user query 492C and generate a programmatic recipe 442 for the conversational user query 492C. For example, in the third example 600C, the orchestrator 422 may generate a programmatic recipe 442 that assigns retriever tasks 444 to the retriever tool 424 to compare the user’s 401 short-term user-specific interactions and listening patterns 465A, 464A to the user’s 401 long-term user-specific interactions and listening patterns 465B, 464B.

In response to the comparison, the retriever tool 424 may generate comparison data and format the comparison data into the structured data 472. The retriever tool 424 may provide structured data 472 to the parser tool 428, and the parser tool 428 may generate the conversational output 494C in the third example 600C. As illustrated in FIG. 6, the conversational output 494C may be formatted in such a manner as to reflect a conversational response by a human being. The parser tool 428 may use the language model 702 to generate the conversational output 494C.

### VI. Example Architecture

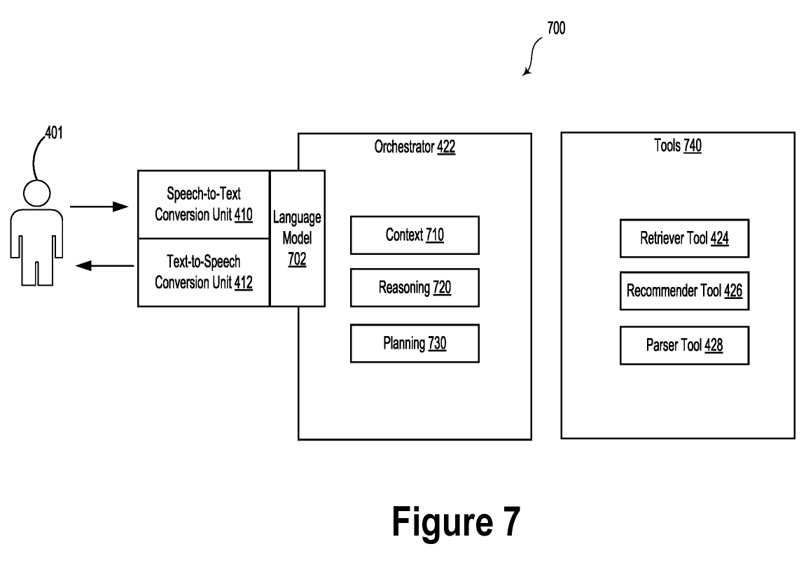

FIG. 7 is a diagram illustrating an example architecture 700, in accordance with some embodiments. The architecture 700 includes the speech-to-text conversion unit 410, the text-to-speech conversion unit 412, the orchestrator 422, a language model 702, and a plurality of tools.

In FIG. 7, the speech-to-text conversion unit 410 may be configured to perform the speech-to-text conversion operation on user queries from the user 401 to generate the conversational user query 492, and the conversational user query 492 may be provided to the orchestrator 422.

The orchestrator 422 may be configured to utilize the language model 702 to determine a context 710 of the conversational user query 492. Based on the context 710, the orchestrator 422 may perform reasoning 720 and planning 730 to determine (i) which tools 740 should be used and (ii) how each tool 740 should be used to process the conversational user query 492. For example, the orchestrator 422 may perform reasoning 720 and planning 730 to generate the programmatic recipe 442 for processing the conversational user query 492. The programmatic recipe 442 may specify one or more of (i) how the retriever tool 424 is to be used in processing the conversational user query 492 and (ii) how the recommender tool 426 is to be used in processing the conversational user query 492.

The orchestrator 422 may utilize the retriever tool 424 and/or the recommender tool 426 according to the programmatic recipe 442 to generate the structured data 472, 476, as described with respect to FIG. 4. The parser tool 428 may be configured to generate the conversational output 494 based on the structured data 472 and the structured data 476. To generate the conversational output 494, the parser tool 428 may utilize the language model 702. For example, the structured data 472, 476 may be provided as an input to the language model 702, and the language model 702 may output the conversational output 494.

The conversational output 494 may be provided to the text-to-speech conversion unit 412. The text-to-speech conversion unit 412 may be configured to perform a text-to-speech conversation operation on the conversational output 494 to generate an audible conversational output 496.

### VII. Example Natural Language Models

As discussed above, the embodiments herein may employ natural language models. Language models (LMs) are one example of such a natural language model. These LMs may operate as networked servers that take in information from a client device as a prompt and provide a semantically appropriate response as output to the client device.

In general, an LM is an advanced computational model, primarily functioning within the domain of natural language processing and machine learning. An LM can be configured to understand, interpret, generate, and respond to human language in a manner that is both contextually relevant and syntactically coherent. The underlying structure of an LM is typically based on a neural network architecture, more specifically, a variant of the transformer model. Transformers are notable for their ability to process sequential data, such as text, with high efficiency.

The operation of an LM involves layers of interconnected processing units, known as neurons, which collectively form a deep neural network. This network can be trained on vast datasets comprising text from diverse sources, thereby enabling the LM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LM’s output and expected output.

An aspect of an LM’s functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model’s ability to generate contextually relevant and coherent text by understanding the relationships and dependencies between words or tokens in a sentence (or longer parts of texts), regardless of their position.

Upon receiving an input, such as a text query or a prompt, the LM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LMs highly versatile and applicable in various domains, including but not limited to, chatbot development, content creation, language translation, and sentiment analysis.

Some LMs are multimodal in that they can receive prompts in formats other than text and can produce outputs in formats other than text. Thus, while LMs are predominantly designed for understanding and generating textual data, multimodal LMs extend this functionality to include multiple data modalities, such as visual and auditory inputs, in addition to text.

A multimodal LM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LM involves multimodal datasets, enabling the model to learn not only language patterns but also the correlations and interactions between different types of data. This cross-modal training results in multimodal LMs being adept at tasks that require an understanding of complex relationships across multiple data forms, a capability that text-only LMs do not possess. This makes multimodal LMs particularly suited for advanced applications that necessitate a holistic understanding of multimodal information, such as chatbots that can interpret and produce images and/or audio.

### VIII. Example Operations

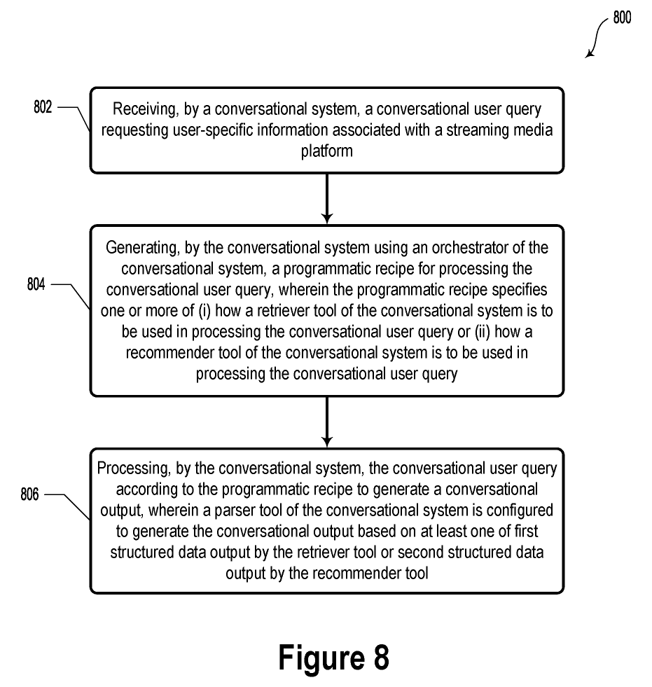

FIG. 8 is a flow chart illustrating an example embodiment. The method 800 illustrated by FIG. 8 may be carried out by a computing device, such as the device 400. Alternatively, the process can be carried out by other types of devices or device subsystems. The embodiments of FIG. 8 may be simplified by the removal of any one or more of the features or blocks shown therein. Further, these embodiments may be combined with features, blocks, aspects, and/or implementations of any of the previous figures or otherwise described herein.

The method 800 includes receiving, by a conversational system, a conversational user query requesting user-specific information associated with a streaming media platform, at block 802. For example, referring to FIG. 4, the conversational system 420 may receive the conversational user query 492. The conversational user query 492 may request user-specific information associated with the streaming media platform. As non-limiting examples, the conversational user query 492 may include any of the queries 492A-492C in the examples 600A-600C of FIG. 6.

The method 800 includes generating, by the conversational system using an orchestrator of the conversational system, a programmatic recipe for processing the conversational user query, at block 804. The programmatic recipe specifies one or more of (i) how a retriever tool of the conversational system is to be used in processing the conversational user query or (ii) how a recommender tool of the conversational system is to be used in processing the conversational user query. For example, referring to FIG. 4, the orchestrator 422 generates the programmatic recipe 442 for processing the conversational user query 492. The programmatic recipe 442 specifies (i) how the retriever tool 424 is to be used in processing the conversational user query 492 and (ii) how the recommender tool 426 is to be used in processing the conversational user query 492. To process at least part of the conversational user query 492, the retriever tool 424 is configured to (i) access the memory 430 that stores information indicative of user-specific interactions with the streaming media platform and (ii) output first structured data 472 representing select user-specific interactions 474 with the streaming media platform. To process at least part of the conversational user query 492, the recommender tool 426 is configured to (i) communicate with one or more recommendation systems of the streaming media platform and (ii) output second structured data 476 representing select user-specific media recommendations 478 associated with the streaming media platform. In some embodiments of the method 800, the programmatic recipe indicates one or more tools, of a plurality of tools, to be used to process the conversational user query. The plurality of tools includes at least the retriever tool and the recommender tool.

The method 800 includes processing, by the conversational system, the conversational user query according to the programmatic recipe to generate a conversational output, at block 806. A parser tool of the conversational system is configured to generate the conversational output based on at least one of first structured data output by the retriever tool or second structured data output by the recommender tool. For example, referring to FIG. 4, the conversational system 420 processes the conversational user query 492 according to the programmatic recipe 442 to generate the conversational output 494. The parser tool 428 generates the conversational output 494 based on at least first structured data 472 or the second structured data 476.

According to one implementation, the method 800 also includes assigning, by the orchestrator, one or more retriever tasks for the retriever tool based on the programmatic recipe. The retriever tool generates the first structured data in response to performing the one or more retriever tasks.

According to one implementation, the method 800 also includes assigning, by the orchestrator and as part of the programmatic recipe, one or more retriever tasks for the retriever tool. The retriever tool generates the first structured data in response to performing the one or more retriever tasks.

According to one implementation of the method 800, performing the one or more retriever tasks includes identifying, by the retriever tool and based on the information stored in the memory, historical user listening patterns associated with media content items on the streaming media platform. Performing the one or more retriever tasks also includes generating, by the retriever tool, the first structured data based at least in part on the historical user listening patterns. According to one implementation of the method 800, the historical user listening patterns includes short-term user listening patterns for a first time period and long-term user listening patterns for a second time period that includes the first time period. According to one implementation, generating the first structured data includes (i) assigning, by the retriever tool, a first weight to the short-term user listening patterns to generate a first subset of the first structured data and (ii) assigning, by the retriever tool, a second weight to the long-term user listening patterns to generate a second subset of the first structured data. The first weight may be greater than the second weight. The first structured data includes the first subset of the first structured data and the second subset of the first structured data. According to some implementations, the historical user listening patterns indicate one or more of peak listening hours, play frequency, or streaks.

According to one implementation, the method 800 includes assigning, by the orchestrator, one or more recommender tasks for the recommender tool based on the programmatic recipe. The recommender tool generates the second structured data in response to performing the one or more recommender tasks. According to one implementation of the method 800, performing the one or more recommender tasks includes (i) recommending, by the recommender tool, one or more media content items on the streaming media platform based on previously accessed media content items and (ii) generating, by the recommender tool, the second structured data based at least in part on the one or more media content items. According to one implementations, the method 800 also includes determining the previously accessed media content items based on the information stored in the memory.

According to one implementation, the method 800 includes assigning, by the orchestrator and as part of the programmatic recipe, one or more recommender tasks for the recommender tool. The recommender tool generates the second structured data in response to performing the one or more recommender tasks.

According to one implementation of the method 800, at least part of the conversational system is integrated in to a language mode. According to one implementation, the orchestrator and the parser tool are integrated into the language model. In some embodiments, the language model includes a LLM. In some embodiments, the language model is hosted by a media playback device. In some embodiments, the language model is hosted by a media server associated with the streaming media platform.

The method 800 of FIG. 8 enables the conversational system 420 to generate the conversational output 494 to the conversational user query 492 based on user-specific information (e.g., listening patterns 464 and interactions 465). As a result, user experience may be enhanced such that the user 401 feels as if he or she is having a conversation. For example, and as further described with respect to FIG. 6, the format of the conversational output 494 can vary based on the context of the conversational user query 492. To illustrate, the conversational output 494 can be used to poke fun of the user’s 401 listening taste, create a hypothetical festival lineup for the user 401, provide thoughtful analysis of the user’s 401 listening history, etc.

To generate the conversational output 494, the orchestrator 422 uses a language model to (i) interpret (e.g., understand) the conversational user query 492 and (ii) generate the programmatic recipe 442 that defines the different agents (e.g., tools 424, 426) involved with processing the conversational user query 492. The retriever tool 424 may fetch and analyze the user’s 401 listening history (e.g., tracks, artists, genres, etc.) and may access the memory 430 (e.g., a long-term memory module) that detects user listening patterns 464 for an accurate temporal analysis. The recommender tool 426 provides contextualized music suggestions via recommendations services available to the streaming media platform. The parser tool 428 converts the structured data 472, 476 (e.g., structured metadata) collected through the retriever and recommender tools 424, 426 into the conversational output 494 using a language model.

### IX. Example Non-Transitory Computer-Readable Media

Some or all of the operations described herein may be embodied in a non-transitory computer-readable medium. Such a computer-readable medium has stored thereon program instructions that, upon execution by a computing system, cause the computing system to perform various operations.

The program instructions could be configured for receiving a conversational user query requesting user-specific information associated with a streaming media platform.

The program instructions could also be configured for generating a programmatic recipe for processing the conversational user query. The programmatic recipe specifies one or more of (i) how a retriever tool of the conversational system is to be used in processing the conversational user query and (ii) how a recommender tool of the conversational system is to be used in processing the conversational user query. To process at least part of the conversational user query, the retriever tool is configured to access a memory that stores information indicative of user-specific interactions with the streaming media platform and output first structured data representing select user-specific interactions with the streaming media platform. To process at least part of the conversational user query, the recommender tool is configured to communicate with one or more recommendation systems of the streaming media platform and output second structured data representing select user-specific media recommendations associated with the streaming media platform.

The program instructions are could be configured for processing the conversational user query according to the programmatic recipe to generate a conversational output. A parser tool of the conversational system is configured to generate the conversational output based on at least one of the first structured data or the second structured data.

In some examples, the program instructions could be configured for assigning one or more retriever tasks for the retriever tool based on the programmatic recipe. The retriever tool generates the first structured data in response to performing the one or more retriever tasks.

In some examples, the program instructions could be configured for assigning one or more recommender tasks for the recommender tool based on the programmatic recipe. The recommender tool generates the second structured data in response to performing the one or more recommender tasks.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method of generating conversational outputs to user queries, the method comprising:
receiving, by a conversational system, a conversational user query requesting user-specific information associated with a streaming media platform;
generating, by the conversational system using an orchestrator of the conversational system, a programmatic recipe for processing the conversational user query, wherein the programmatic recipe specifies one or more of:
(i) how a retriever tool of the conversational system is to be used in processing the conversational user query, wherein, to process at least part of the conversational user query, the retriever tool is configured to:
access a memory that stores information indicative of user-specific interactions with the streaming media platform; and
output first structured data representing select user-specific interactions with the streaming media platform; or
(ii) how a recommender tool of the conversational system is to be used in processing the conversational user query, wherein, to process at least part of the conversational user query, the recommender tool is configured to:
communicate with one or more recommendation systems of the streaming media platform; and
output second structured data representing select user-specific media recommendations associated with the streaming media platform; and
processing, by the conversational system, the conversational user query according to the programmatic recipe to generate a conversational output, wherein a parser tool of the conversational system is configured to generate the conversational output based on at least one of the first structured data or the second structured data.

2. The method of claim 1, further comprising assigning, by the orchestrator and as part of the programmatic recipe, one or more retriever tasks for the retriever tool, wherein the retriever tool generates the first structured data in response to performing the one or more retriever tasks.

3. The method of claim 2, wherein performing the one or more retriever tasks comprises:
identifying, by the retriever tool and based on the information stored in the memory, historical user listening patterns associated with media content items on the streaming media platform; and
generating, by the retriever tool, the first structured data based at least in part on the historical user listening patterns.

4. The method of claim 3, wherein the historical user listening patterns comprise:
short-term user listening patterns for a first time period; and
long-term user listening patterns for a second time period that includes the first time period.

5. The method of claim 4, wherein generating the first structured data comprises:
assigning, by the retriever tool, a first weight to the short-term user listening patterns to generate a first subset of the first structured data; and
assigning, by the retriever tool, a second weight to the long-term user listening patterns to generate a second subset of the first structured data, wherein the first weight is greater than the second weight,
wherein the first structured data includes the first subset of the first structured data and the second subset of the first structured data.

6. The method of claim 3, wherein the historical user listening patterns indicate one or more of peak listening hours, play frequency, or streaks.

7. The method of claim 1, further comprising assigning, by the orchestrator and as part of the programmatic recipe, one or more recommender tasks for the recommender tool, wherein the recommender tool generates the second structured data in response to performing the one or more recommender tasks.

8. The method of claim 7, wherein performing the one or more recommender tasks comprises:
recommending, by the recommender tool, one or more media content items on the streaming media platform based on previously accessed media content items; and
generating, by the recommender tool, the second structured data based at least in part on the one or more media content items.

9. The method of claim 8, further comprising determining the previously accessed media content items based on the information stored in the memory.

10. The method of claim 1, wherein the programmatic recipe indicates one or more tools, of a plurality of tools, to be used to process the conversational user query, wherein the plurality of tools includes at least the retriever tool and the recommender tool.

11. The method of claim 1, wherein at least part of the conversational system is integrated into a language model.

12. The method of claim 11, wherein the orchestrator and the parser tool are integrated into the language model.

13. The method of claim 11, wherein the language model is hosted by a media playback device.

14. The method of claim 11, wherein the language model is hosted by a media server associated with the streaming media platform.

15. A device comprising:
a system memory;
a processor coupled to the system memory, the processor hosting a conversational system configured to:
receive a conversational user query requesting user-specific information associated with a streaming media platform;
generate, using an orchestrator of the conversational system, a programmatic recipe for processing the conversational user query, wherein the programmatic recipe specifies one or more of:
(i) how a retriever tool of the conversational system is to be used in processing the conversational user query, wherein, to process at least part of the conversational user query, the retriever tool is configured to:
access a memory that stores information indicative of user-specific interactions with the streaming media platform; and
output first structured data representing select user-specific interactions with the streaming media platform; or
(ii) how a recommender tool of the conversational system is to be used in processing the conversational user query, wherein, to process at least part of the conversational user query, the recommender tool is configured to:
communicate with one or more recommendation systems of the streaming media platform; and
output second structured data representing select user-specific media recommendations associated with the streaming media platform; and
process the conversational user query according to the programmatic recipe to generate a conversational output, wherein a parser tool of the conversational system is configured to generate the conversational output based on at least one of the first structured data or the second structured data.

16. The device of claim 15, wherein the conversational system is further configured to assign, by the orchestrator and as part of the programmatic recipe, one or more retriever tasks for the retriever tool, wherein the retriever tool generates the first structured data in response to performing the one or more retriever tasks.

17. The device of claim 16, wherein, to perform the one or more retriever tasks, the conversational system is configured to:
identify, by the retriever tool and based on the information stored in the memory, historical user listening patterns associated with media content items on the streaming media platform; and
generate, by the retriever tool, the first structured data based at least in part on the historical user listening patterns.

18. The device of claim 15, wherein the conversational system is further configured to assign, by the orchestrator and as part of the programmatic recipe, one or more recommender tasks for the recommender tool, wherein the recommender tool generates the second structured data in response to performing the one or more recommender tasks.

19. The device of claim 18, wherein, to perform the one or more recommender tasks, the conversational system is configured to:
recommend, by the recommender tool, one or more media content items on the streaming media platform based on previously accessed media content items; and
generate, by the recommender tool, the second structured data based at least in part on the one or more media content items.

20. A non-transitory computer-readable medium comprising instructions that, when executed by a processor that hosts a conversational system, cause the conversational system to perform operations comprising:
receiving a conversational user query requesting user-specific information associated with a streaming media platform;
generating, using an orchestrator of the conversational system, a programmatic recipe for processing the conversational user query, wherein the programmatic recipe specifies one or more of:
(i) how a retriever tool of the conversational system is to be used in processing the conversational user query, wherein, to process at least part of the conversational user query, the retriever tool is configured to:
access a memory that stores information indicative of user-specific interactions with the streaming media platform; and
output first structured data representing select user-specific interactions with the streaming media platform; or
(ii) how a recommender tool of the conversational system is to be used in processing the conversational user query, wherein, to process at least part of the conversational user query, the recommender tool is configured to:
communicate with one or more recommendation systems of the streaming media platform; and
output second structured data representing select user-specific media recommendations associated with the streaming media platform; and
processing the conversational user query according to the programmatic recipe to generate a conversational output, wherein a parser tool of the conversational system is configured to generate the conversational output based on at least one of the first structured data or the second structured data.
